(19) United States
(12) Patent Application Publication
(10) Pub. No.: US 2008/0302197 A1
(43) Pub. Date: Dec. 11, 2008

(54) Ball screw device having bearing spacer

(75) Inventors: Chia Min Liu, Taichung (TW); Kenny Lin, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 11/810,318

(22) Filed: Jun. 5, 2007

(51) Int. Cl. F16H 25/22

(52) U.S. Cl. 74/424.82

(57) ABSTRACT

A ball screw device includes a ball nut having an inner thread formed by a number of helical groove portions for forming an endless ball rolling passage in the ball nut and for receiving a number of bearing members, and an endless spacer moving passage formed in the ball nut and communicating with the endless ball rolling passage of the ball nut for receiving a number of bearing spacers which are engaged between the bearing members for spacing the bearing members away from each other and for preventing the bearing members from striking onto each other. The bearing spacers may be spherical bearing spacers, and made of synthetic materials.

### BACKGROUND OF THE INVENTION

1. Field of the Invention

The present invention relates to a ball screw device, and more particularly to a ball screw device having an endless ball train guiding passage formed therein for smoothly receiving and guiding the ball bearing members to move relative to the ball nut and the screw shaft, and a number of bearing spacers disposed between the ball bearing members for suitably spacing the ball bearing members from each other and for preventing the ball bearing members from striking onto each other and for silencing purposes.

2. Description of the Prior Art

Typical ball screw devices comprise a ball nut rotatably and/or moveably engaged onto a screw shaft, and normally arranged to allow the ball nut to be rotated and/or moved relative to the screw shaft in great rotational speeds. For allowing the ball nut to be smoothly rotated and moved relative to the screw shaft, a suitable bearing device or lubricating structure is further required to be provided and engaged between the ball nut and the screw shaft, for facilitating the rotational movement between the ball nut and the screw shaft.

For example, U.S. Pat. No. 5,014,568 to Schlenker discloses one of the typical ball screw devices including a deflecting member provided or engaged into the ball nut for forming a ball return passage or an endless ball train guiding passage and for receiving a number of balls or a ball train therein, and for allowing the balls or the ball train to be engaged between the ball nut and the screw shaft to facilitate the rotational movement between the ball nut and the screw shaft.

In Schlenker, the balls may be loosely received in the endless ball train guiding passage and are not spaced away from each other and may have a good chance to strike onto each other while moved along the endless ball train guiding passage of the ball nut, such that a great noise will be generated by the striking of the balls.

U.S. Pat. No. 5,063,809 to Schlenker discloses another typical ball screw device including a different type of deflecting member attached to or engaged into the ball nut and having a deflecting passage formed therein for guiding or deflecting the balls or the ball train.

However, similarly, the balls may also be loosely received in the endless ball train guiding passage and are not spaced away from each other and also may have a good chance to strike onto each other while moved along the endless ball train guiding passage of the ball nut, such that a great noise will be generated by the striking of the balls.

U.S. Pat. No. 5,193,409 to Babinski discloses a further typical ball screw device including a different type of deflecting member or insert attached to or engaged into the ball nut and having a ball guiding passage formed therein for guiding or deflecting the balls or the ball train.

However, similarly, the balls may also be loosely received in the endless ball train guiding passage and are not spaced away from each other and also may have a good chance to strike onto each other while moved along the endless ball train guiding passage of the ball nut, such that a great noise will be generated by the striking of the balls.

U.S. Pat. No. 5,492,036 to Sato discloses a still further typical ball screw device including two end caps attached to or engaged onto the end portions of the ball nut and each having a ball guiding passage formed therein for guiding or deflecting the balls or the ball train.

However, similarly, the balls may also be loosely received in the endless ball train guiding passage and are not spaced away from each other and also may have a good chance to strike onto each other while moved along the endless ball train guiding passage of the ball nut, such that a great noise will be generated by the striking of the balls.

U.S. Pat. No. 5,809,838 to Miyaguchi et al. discloses a still further typical ball screw device including one or more different types of deflecting members or inserts attached to or engaged into the ball nut and having a ball guiding passage formed therein for guiding or deflecting the balls or the ball train.

However, similarly, the balls may also be loosely received in the endless ball train guiding passage and are not spaced away from each other and also may have a good chance to strike onto each other while moved along the endless ball train guiding passage of the ball nut, such that a great noise will be generated by the striking of the balls.

U.S. Pat. No. 6,023,991 to Yabe et al. discloses a still further typical ball screw device lubricated with oil-containing polymer including a ball guiding passage formed therein for guiding or deflecting the bearing balls or the ball train, and a number of spacer balls engaged between the bearing balls.

However, the spacer balls include an outer diameter slightly smaller than that of the bearing balls such that the spacing distance between the bearing balls is almost equals to or slightly smaller than the outer diameter of the bearing balls, and the spacing distance between the bearing balls may be different when the spacer balls are positioned or located at different height or position relative to the bearing balls or at different height or position relative to the ball guiding passage of the ball screw device.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including an endless ball train guiding passage formed therein for smoothly receiving and guiding the ball bearing members to move relative to the ball nut and the screw shaft, and a number of bearing spacers disposed between the ball bearing members for suitably spacing the ball bearing members from each other and for preventing the ball bearing members from striking onto each other and for silencing purposes.

In accordance with one aspect of the invention, there is provided a ball screw device comprising a ball nut including a bore formed therein, and including an inner thread formed therein and defined by a number of helical groove portions for forming an endless ball rolling passage in the ball nut, and including an endless spacer moving passage in the ball nut and communicating with the endless ball rolling passage of the ball nut, a number of bearing members engaged in the endless ball rolling passage of the ball nut, and a number of spherical bearing spacers engaged in the endless spacer moving passage of the ball nut and engaged between the bearing members for spacing the bearing members away from each other and for preventing the bearing members from striking onto each other.

The ball nut includes at least one deflecting member attached thereto and having a curved passageway formed in the deflecting member and communicating with the inner thread of the ball nut for forming the endless ball rolling passage in the ball nut.

The ball nut includes a channel formed in the ball nut and communicating with the curved passageway of the deflecting member for forming the endless ball rolling passage of the ball nut. The ball nut includes a path formed in the ball nut and communicating with the channel of the ball nut for receiving the spherical bearing spacers.

The deflecting member includes a curved pathway formed in the deflecting member and communicating with the curved passageway of the deflecting member for receiving the spherical bearing spacers. The ball nut includes a helical slot formed therein and communicating with the curved pathway of the deflecting member for receiving the spherical bearing spacers.

The ball nut includes a depression formed therein and communicating with the bore and the helical groove portions and the inner thread of the ball nut for receiving the deflecting member. The bearing members are ball bearing members. The spherical bearing spacers are made of synthetic materials.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective of a ball nut and a ball bearing members and two deflecting members for a ball screw device in accordance with the present invention, in which a quarter of the ball nut has been cut off for showing an inner structure of the ball nut;

FIG. 2 is a perspective view of the ball but, in which a quarter of the ball nut has also been cut off for showing an inner structure of the ball nut;

FIG. 3 is an enlarged perspective view illustrating one of the deflecting members of the ball screw device;

FIG. 4 is a perspective similar to FIG. 1, illustrating the other arrangement of the ball nut and the ball bearing members and the deflecting members for the ball screw device, in which a portion of the ball nut has been cut off for showing an inner structure of the ball nut; and

FIG. 5 is an enlarged perspective view illustrating one of the deflecting members of the ball screw device as shown in FIG. 4.

### DETAILED DESCRIPTION OF THE PREFERRED EMBODIMENT

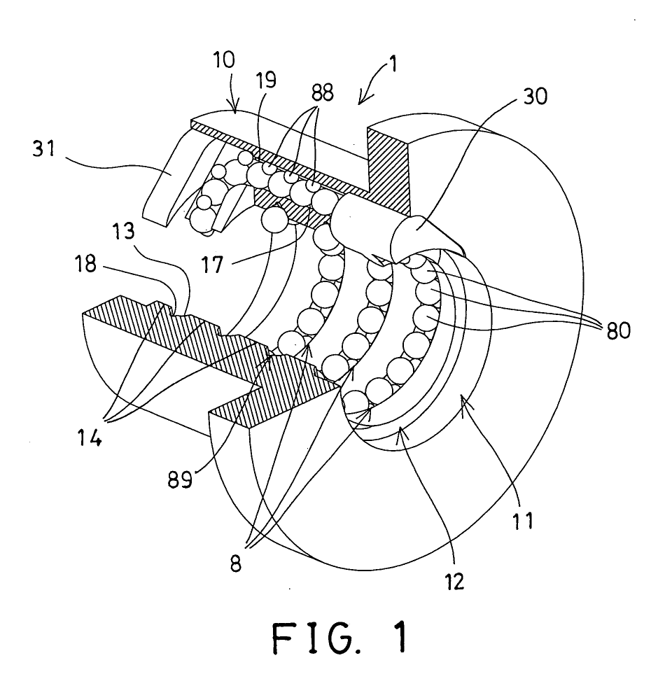

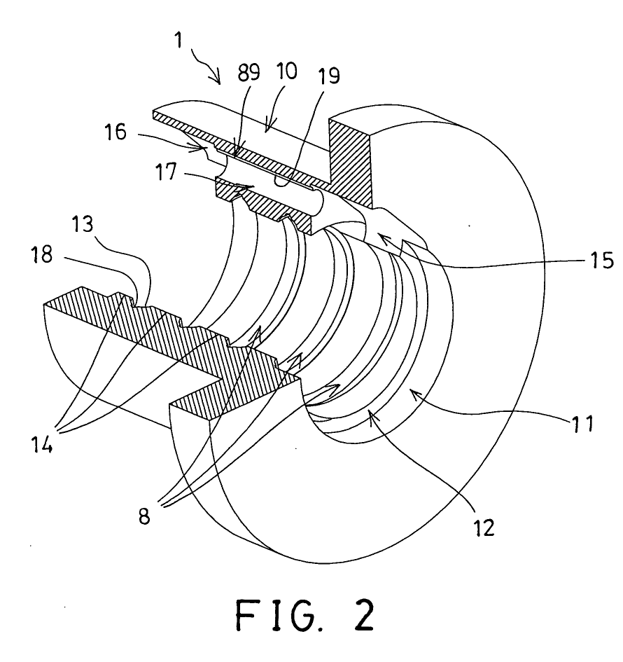

Referring to the drawings, and initially to FIGS. 1-2, a ball screw device 1 in accordance with the present invention comprises an outer ball nut 10 including a bore 11 formed therein and having an inner thread 12 formed therein, the inner thread 12 of the ball nut 10 includes a number of peripheral and helical groove portions 13 formed and defined by a number of peripheral and helical ridges 14 for threading with or for engaging with an outer thread of a typical screw shaft (not shown), and thus for allowing the ball nut 10 to be moved along the screw shaft, or for allowing the screw shaft to be rotated and moved relative to the ball nut 10. The threading engagement and/or the rotational engagement between the ball nut 10 and the screw shaft is typical and has been shown or disclosed in U.S. Pat. No. 5,014,568 to Schlenker, U.S. Pat. No. 5,063,809 to Schlenker, U.S. Pat. No. 5,193,409 to Babinski, U.S. Pat. No. 5,492,036 to Sato, U.S. Pat. No. 5,809,838 to Miyaguchi et al., and U.S. Pat. No. 6,023,991 to Yabe et al. and will not be described in further details.

A multiple turn, helical raceway or endless ball rolling passage 8 will be formed between the ball nut 10 and the screw shaft for rotatably and/or movably receiving one or more groups of balls or rollers or rolling or ball bearing members 80 (FIG. 1) therein which may facilitate the rotating movement of the ball nut 10 relative to the screw shaft when the screw shaft is forced to rotate relative to the ball nut 10 or when the ball nut 10 is forced to rotate relative to the screw shaft, in order to constitute the primary or basic structure of the ball screw device 1. The ball nut 10 includes one or more (such as two) depressions 15, 16 formed therein and communicating with the bore 11 and the helical groove portions 13 or the inner thread 12 of the ball nut 10 and each for receiving a ball guide or deflecting member 30, 31 therein. The ball nut 10 further includes one or more channels 17 formed therein and communicating with the depressions 15, 16 of the ball nut 10, and the channel 17 is longitudinally formed in the ball nut 10 and passing through or intersecting or communicating with the depressions 15, 16 of the ball nut 10, best shown in FIG. 2.

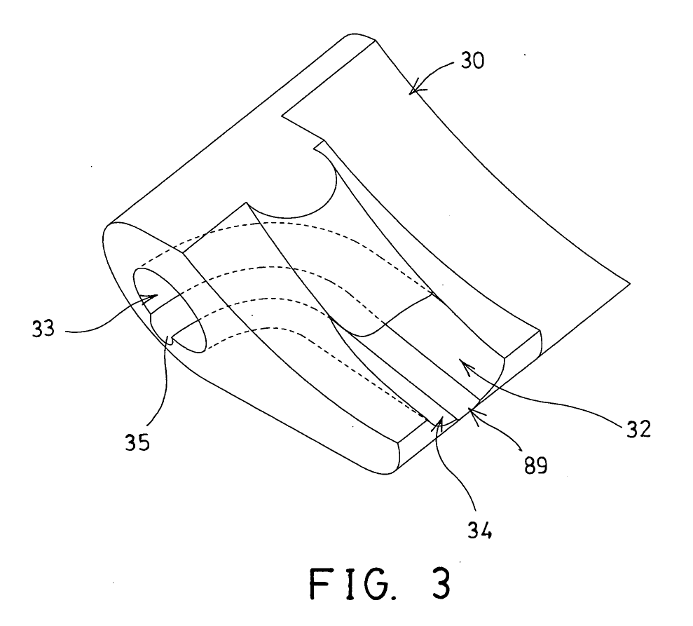

The ball guide or deflecting members 30, 31 are provided for engaging into the depressions 15, 16 of the ball nut 10 respectively, and each include a shape or structure identical or corresponding to that of the depressions 15, 16 of the ball nut 10 respectively for snugly engaging into the depressions 15, 16 of the ball nut 10 respectively, and the deflecting members 30, 31 may be secured to the ball nut 10 with such as force-fitted engagements, latches or fasteners (not shown), or by adhesive materials, or by welding processes. The deflecting members 30, 31 each include a curved passageway 32 formed therein (FIG. 3) for communicating the channels 17 and the helical groove portions 13 or the inner thread 12 of the ball nut 10 with each other and for guiding the ball bearing members 80 to move into or out of the channels 17 of the ball nut 10 respectively, and thus for forming the endless ball rolling passages 8.

For example, the curved passageways 32 of the deflecting members 30, 31 each include a first mouth 33 and a second mouth 34 formed therein and aligned with and/or communicating with the channels 17 and the helical groove portions 13 or the inner thread 12 of the ball nut 10 respectively for forming the endless ball rolling passages 8 and thus for smoothly guiding the ball bearing members 80 to move into or through or out of the channels 17 and the helical groove portions 13 or the inner thread 12 of the ball nut 10 respectively, and thus for facilitating the rotational and/or the sliding movement between the ball nut 10 and the screw shaft. The above described structure including the formation and the provision of the helical groove portions 13 or the inner thread 12 and the channel 17 in the ball nut 10 and the engagement of the deflecting members 30, 31 in the depressions 15, 16 of the ball nut 10 is typical and will not be described in further details.

The ball screw device 1 in accordance with the present invention further includes a multiple turn, helical slot 18 formed in the ball nut 10 and aligned with and communicating with the helical groove portions 13 or the inner thread 12 of the ball nut 10 and of the endless ball rolling passage 8, and a recessed path 19 formed in the ball nut 10 and aligned with and communicating with the channel 17 of the ball nut 10 and of the endless ball rolling passage 8, a curved pathway 35 formed in each of the deflecting member 30, 31 and aligned with and communicating with the curved passageways 32 of the deflecting members 30, 31 and of the endless ball rolling passage 8 and also communicating with the helical slot 18 and the recessed path 19 of the ball nut 10 and of the endless ball rolling passage 8 for rotatably and/or movably receiving one or more groups of ball shaped or spherical bearing spacers 88 which are engaged between the ball bearing members 80 for suitably spacing the ball bearing members 80 away from each other and for preventing the ball bearing members 80 from contacting or striking onto each other and for silencing purposes.

It is preferable that the bearing spacers 88 are made of soft or resilient rubber or plastic or synthetic materials for suitably spacing the ball bearing members 80 away from each other and also for suitably cushioning the ball bearing members 80 and also for suitably absorbing the shocks or the striking that may be generated between the ball bearing members 80 and thus for suitably reducing the noises that may be generated between the ball bearing members 80. It is to be noted that the bearing spacers 88 are disposed or engaged in the helical slot 18 and the recessed path 19 of the ball nut 10 and the curved pathways 35 of the deflecting members 30, 31 for slightly spacing the ball bearing members 80 away from each other and for preventing the spacing distance between the ball bearing members 80 from being changed.

The helical slot 18 and the recessed path 19 of the ball nut 10 and the curved pathways 35 of the deflecting members 30, 31 may be formed as an endless spacer moving passage 89 which is aligned with and communicating with the endless ball rolling passage 8 for rotatably and/or movably receiving the bearing spacers 88 therein. It is further to be noted that the numbers and the sizes or dimensions or diameters of the bearing spacers 88 may be changed or selected or adjusted or increased or reduced according to or depending on the numbers and the sizes or dimensions or diameters of the ball bearing members 80.

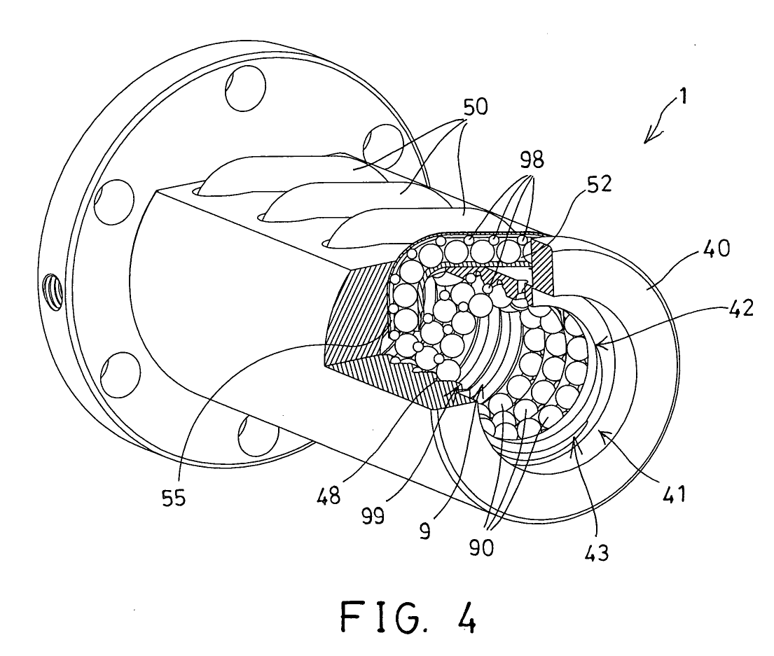

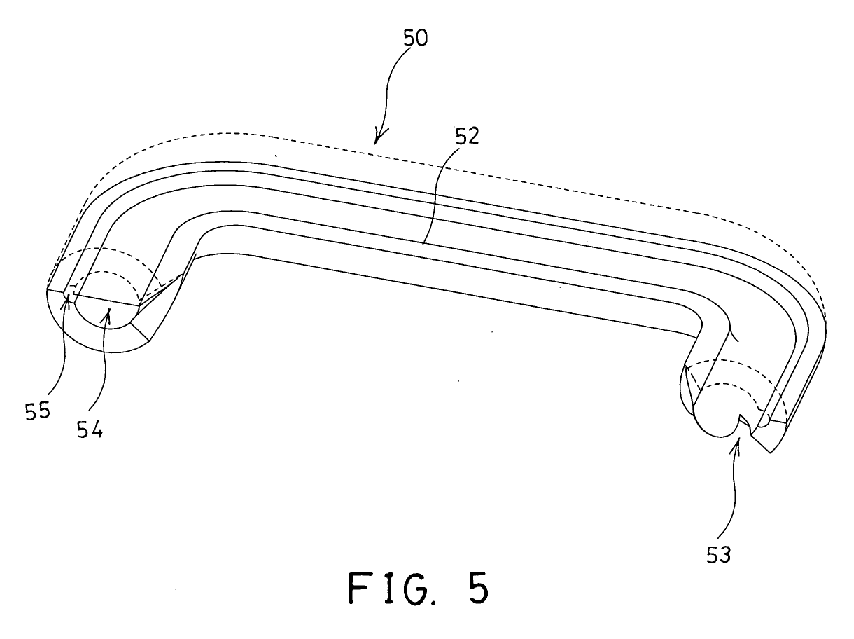

Alternatively, as shown in FIGS. 4-5, the ball screw device 1 in accordance with the present invention also comprises an outer ball nut 40 including a bore 41 formed therein and having an inner thread 42 formed therein, the inner thread 42 of the ball nut 40 includes a number of peripheral and helical groove portions 43 formed therein for threading with or for engaging with an outer thread of a typical screw shaft (not shown), and includes a multiple turn, helical slot 48 formed in the ball nut 40 and aligned with and communicating with the helical groove portions 43 or the inner thread 42 of the ball nut 40 and of the endless ball rolling passage 9, and one or more deflecting members 50 which are different from the deflecting members 30, 31 as shown in FIGS. 1 and 3 are engaged into the ball nut 10 and each include a passageway 52 formed therein (FIG. 5) and having two mouths 53, 54 formed therein and aligned with and/or communicating with the helical groove portions 43 or the inner thread 42 of the ball nut 40 with each other and for guiding the ball bearing members 90 to move into or out of the helical groove portions 43 or the inner thread 42 of the ball nut 40 respectively, and thus for forming the endless ball rolling passages 9.

The ball nut 40 also includes a multiple turn, helical slot 48 formed in the and aligned with and communicating with the helical groove portions 43 or the inner thread 42 of the ball nut 40 and of the endless ball rolling passage 9, and a curved pathway 55 formed in each of the deflecting member 50 and aligned with and communicating with the curved passageways 52 of the deflecting members 50 and of the endless ball rolling passage 9 and also communicating with the helical slot 48 of the ball nut 40 and of the endless ball rolling passage 9 for rotatably and/or movably receiving one or more groups of ball shaped or spherical bearing spacers 98 which may also be engaged between the ball bearing members 90 for suitably spacing the ball bearing members 90 away from each other. The helical slot 48 of the ball nut 40 and the curved pathways 55 of the deflecting members 50 may also be formed as an endless spacer moving passage 99 which is aligned with and communicating with the endless ball rolling passage 9 for rotatably and/or movably receiving the bearing spacers 98 therein.

Accordingly, the ball screw device in accordance with the present invention includes an endless ball train guiding passage formed therein for smoothly receiving and guiding the ball bearing members to move relative to the ball nut and the screw shaft, and a number of bearing spacers disposed between the ball bearing members for suitably spacing the ball bearing members from each other and for preventing the ball bearing members from striking onto each other and for silencing purposes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a ball nut including a bore formed therein, and including an inner thread formed therein and defined by a plurality of helical groove portions for forming an endless ball rolling passage in said ball nut, and including an endless spacer moving passage in said ball nut and communicating with said endless ball rolling passage of said ball nut,
a plurality of bearing members engaged in said endless ball rolling passage of said ball nut, and
a plurality of spherical bearing spacers engaged in said endless spacer moving passage of said ball nut and engaged between said bearing members for spacing said bearing members away from each other and for preventing said bearing members from striking onto each other.

2. The ball screw device as claimed in claim 1, wherein said ball nut includes at least one deflecting member attached thereto and having a curved passageway formed in said at least one deflecting member and communicating with said inner thread of said ball nut for forming said endless ball rolling passage in said ball nut.

3. The ball screw device as claimed in claim 2, wherein said ball nut includes a channel formed in said ball nut and communicating with said curved passageway of said at least one deflecting member for forming said endless ball rolling passage of said ball nut.

4. The ball screw device as claimed in claim 3, wherein said ball nut includes a path formed in said ball nut and communicating with said channel of said ball nut for receiving said spherical bearing spacers.

5. The ball screw device as claimed in claim 2, wherein said at least one deflecting member includes a curved pathway formed in said at least one deflecting member and communicating with said curved passageway of said at least one deflecting member for receiving said spherical bearing spacers.

6. The ball screw device as claimed in claim 5, wherein said ball nut includes a helical slot formed therein and communicating with said curved pathway of said at least one deflecting member for receiving said spherical bearing spacers.

7. The ball screw device as claimed in claim 2, wherein said ball nut includes a depression formed therein and communicating with said bore and said helical groove portions and said inner thread of said ball nut for receiving said at least one deflecting member.

8. The ball screw device as claimed in claim 1, wherein said bearing members are ball bearing members.

9. The ball screw device as claimed in claim 1, wherein said spherical bearing spacers are made of synthetic materials.
